(19) United States
(12) Patent Application Publication
(10) Pub. No.: US 2015/0251309 A1
(43) Pub. Date: Sep. 10, 2015

(54) Display Structure for Tool Box

(71) Applicant: Chen Chao-Ming, Taichung (TW)

(72) Inventor: Chen Chao-Ming, Taichung (TW)

(21) Appl. No.: 14/197,281

(22) Filed: Mar. 5, 2014

(51) Int. Cl. B25H 3/02

(52) U.S. Cl. CPC B25H 3/023

(57) ABSTRACT

A display structure for a tool box contains: a first casing, a second casing, and a connecting assembly. The first casing includes a plurality of first accommodating portions defined therein so as to accommodate a first tool set. The second casing covers with the first casing, and the connecting assembly includes a first connection piece and a second connection piece which are connected together. The first connection piece has a first rotating portion formed on a first end thereof so as to couple with a top surface of the first casing, and the second connection piece has a second rotating portion arranged on a first end thereof so as to couple with a rear side of the second casing.

### FIELD OF THE INVENTION

The present invention relates to a display structure for a tool box which accommodates and displays a first tool set and a second tool set in different spaces.

### BACKGROUND OF THE INVENTION

Referring to FIG. 1, a conventional tool box 10 contains a body 11 for accommodating various tools, a cover 12 for covering the body 11, and a connecting structure for connecting with the body 11 and the cover 12. The connecting structure includes a first rotating seat 111 disposed on a rear side of the body 11 and having a coupling shaft 112. The cover 12 includes a second rotating seat 121 mounted on a rear side thereof and an orifice 122 defined on the second rotating seat 121 and corresponding to the coupling shaft 112, such that the coupling shaft 112 of the body 11 rotates along the orifice 122 of the cover 12 so as to open or close the cover 12.

As shown in FIG. 2, the first tool set in the body 11 are displayed after opening the cover 12 so that the body 11 and the cover 12 are placed on a surface flatly. However, the body 11 and the cover 12 have to be placed in a large space, and when they are fixed at a high position, the first tool set in the body 11 cannot be displayed completely.

With reference to FIG. 3, a display structure for a tool box contains a body 20 for accommodating various tools and a cover 21 for covering the body 20. The body 20 includes a connecting portion 201 disposed on one side thereof so as to connect with a coupling portion 211 of the cover 21, and the cover 21 is opened after rotating the connecting portion 201 and the coupling portion 211. As illustrated in FIG. 4, when the cover 21 is rotated backward to contact with a table, the body 20 is rotated to abut against the cover 21, such that the various tools in the body 20 are placed upright so as to display the various tools. Nevertheless, such a display structure is limited by a height easily, and an inner surface of the cover 21 downward faces to and connect with the table, so the inner surface of the cover 21 cannot accommodate the various tools.

The present invention has arisen to mitigate and/or obviate the afore-described disadvantages.

### SUMMARY OF THE INVENTION

The primary objective of the present invention is to provide a display structure for a tool box which accommodates and displays a first tool set and a second tool set in different spaces.

Another objective of the present invention is to provide a display structure for a tool box in which a second casing includes a second accommodating portion for accommodating a second tool set, and the first casing is opened to horizontally, upright or stackedly display the first tool set by using a first rotating portion and a second rotating portion of the connecting assembly, and since the second casing is placed on a surface flatly, the second accommodating portion of the second casing faces upwardly so that the second tool set in the second accommodating portion is accommodated in the second casing securely.

To obtain the above objectives, a display structure for a tool box provided by the present invention contains: a first casing, a second casing, and a connecting assembly.

The first casing includes a plurality of first accommodating portions defined therein so as to accommodate a first tool set. The second casing covers with the first casing, and the connecting assembly includes a first connection piece and a second connection piece which are connected together. The first connection piece has a first rotating portion formed on a first end thereof so as to couple with a top surface of the first casing, and the second connection piece has a second rotating portion arranged on a first end thereof so as to couple with a rear side of the second casing.

### BRIEF DESCRIPTION OF THE DRAWINGS

FIG. 1 is a perspective view of a conventional tool box.

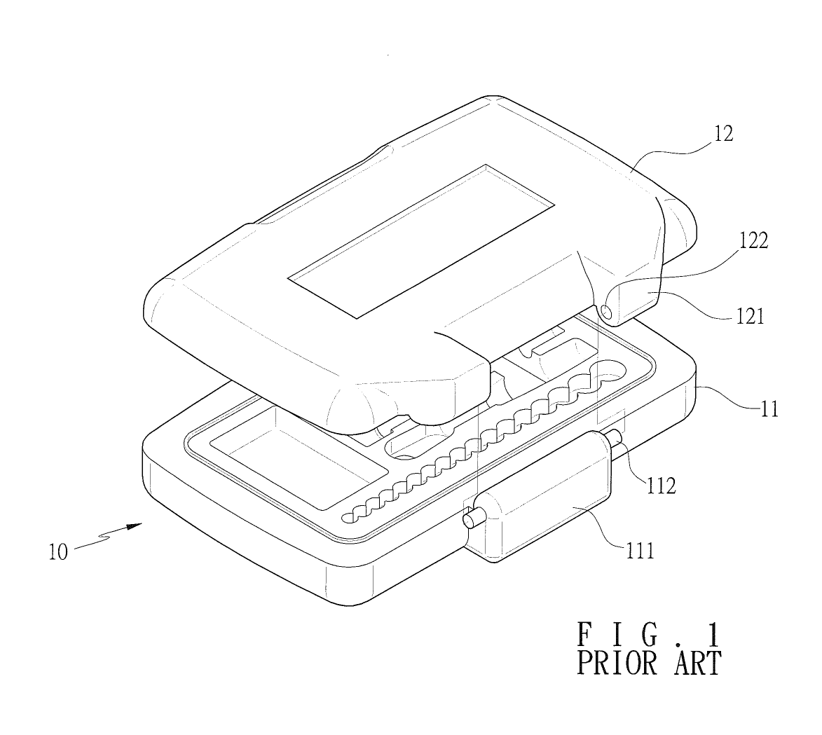

FIG. 2 is a perspective view showing the operation of the conventional tool box.

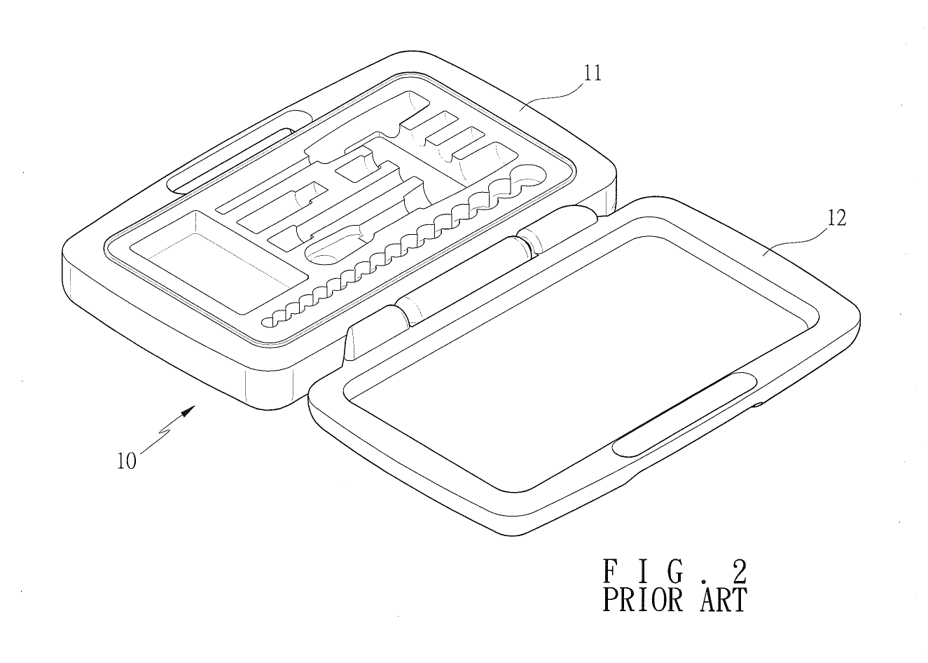

FIG. 3 is a perspective view of a tool box disclosed in TW Filing No. 93210742.

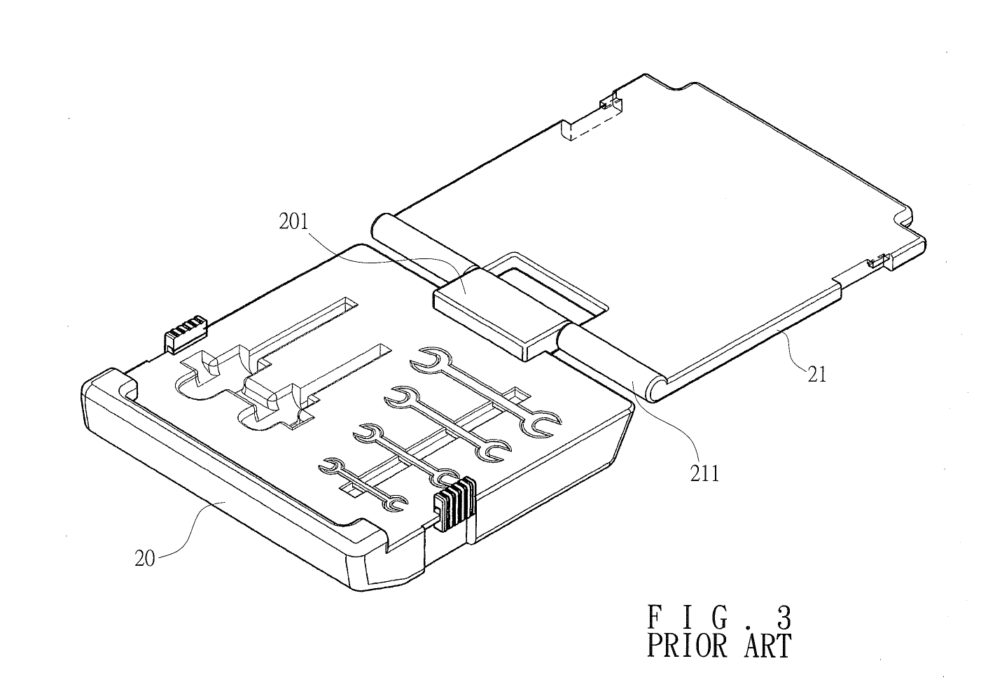

FIG. 4 is a perspective view showing the operation of the tool box disclosed in TW Filing No. 93210742.

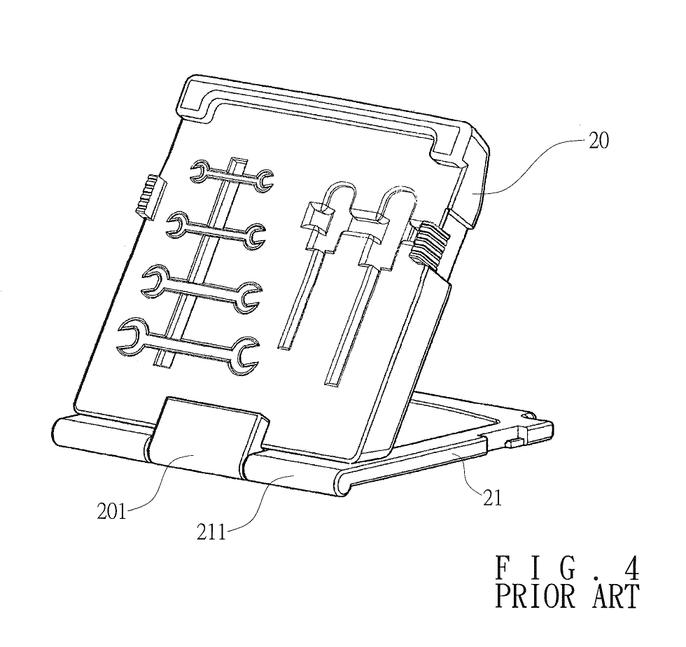

FIG. 5 is a perspective view showing the exploded components of a display structure for a tool box according to a preferred embodiment of the present invention.

FIG. 6 is another perspective view showing the exploded components of the display structure for the tool box according to the preferred embodiment of the present invention.

FIG. 7 is a perspective view showing the assembly of the display structure for the tool box according to the preferred embodiment of the present invention.

FIG. 8 is a cross sectional view showing the assembly of the display structure for the tool box according to the preferred embodiment of the present invention.

FIG. 9 is a perspective view showing the operation of the display structure for the tool box according to the preferred embodiment of the present invention.

FIG. 10 is a cross sectional view showing the operation of the display structure for the tool box according to the preferred embodiment of the present invention.

FIG. 11 is another perspective view showing the operation of the display structure for the tool box according to the preferred embodiment of the present invention.

FIG. 12 is another cross sectional view showing the operation of the display structure for the tool box according to the preferred embodiment of the present invention.

FIG. 13 is also another perspective view showing the operation of the display structure for the tool box according to the preferred embodiment of the present invention.

FIG. 14 is also another cross sectional view showing the operation of the display structure for the tool box according to the preferred embodiment of the present invention.

### DETAILED DESCRIPTION OF THE PREFERRED EMBODIMENTS

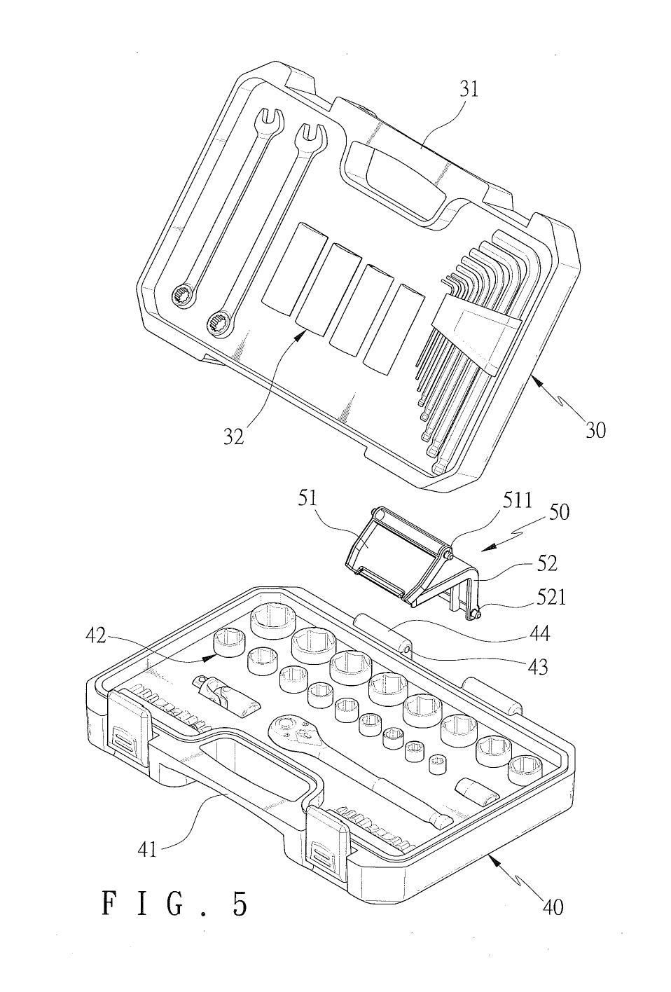

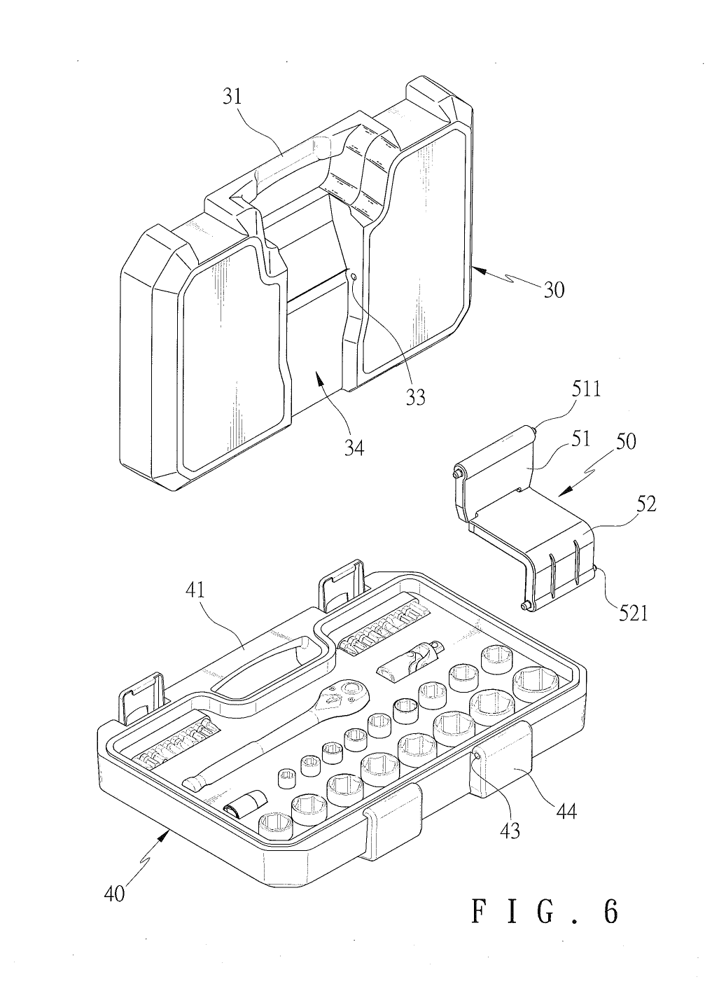

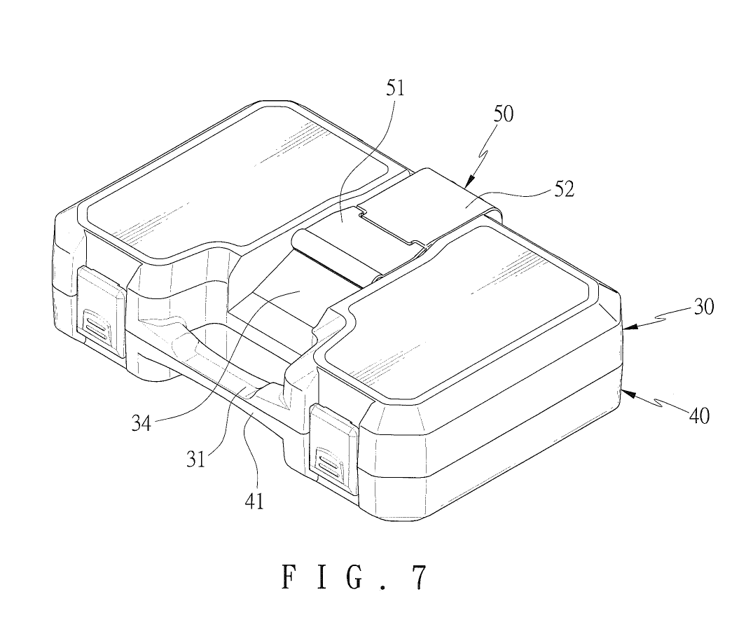

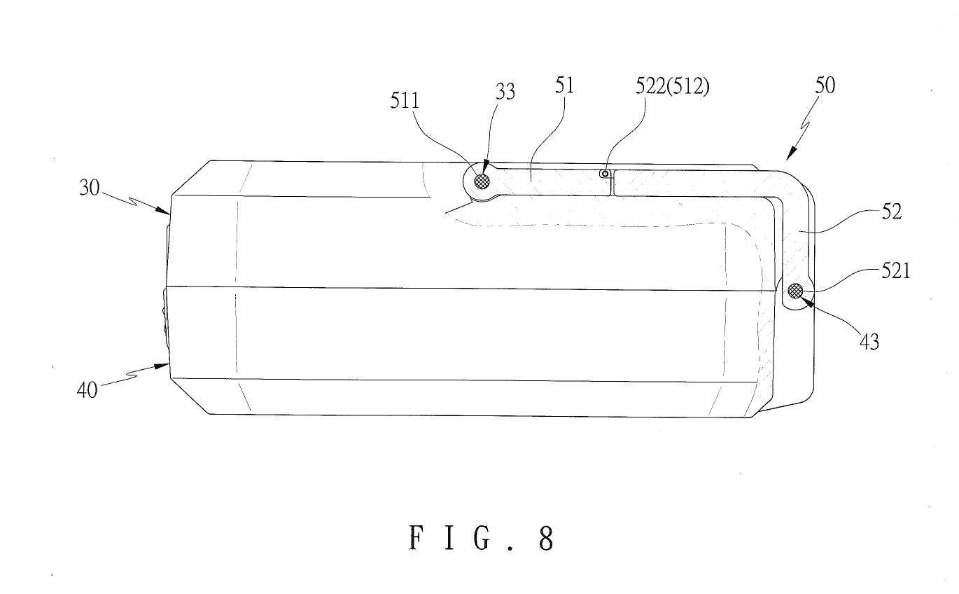

With reference to FIGS. 5 to 8, a display structure for a tool box according to a preferred embodiment of the present invention comprises: a first casing 30, a second casing 40, and a connecting assembly 50 for connecting the first casing 30 and the second casing 40 together. The first casing 30 includes a first griping portion 31 disposed on a front end thereof, a plurality of first accommodating portions 32 defined therein so as to accommodate a first tool set; the second casing 40 covers with the first casing 30 and includes a second griping portion 41 mounted on a front end thereof, such that when the first casing 30 covers with the second casing 40, the first griping portion 31 of the first casing 30 connects with the second griping portion 41 of the second casing 40 so that a user holds a connection of the first griping portion 31 and the second griping portion 41. The second casing 40 includes a concave area or a receiving portion for receiving a second tool set. In this embodiment, the second casing 40 includes a second accommodating portion 42 defined therein so as to accommodate the second tool set. The connecting assembly 50 includes a first connection piece 51 and a second connection piece 52 which are connected together, the first connection piece 51 has a first rotating portion formed on a first end thereof so as to couple with a top surface of the first casing 30, and the second connection piece 52 has a second rotating portion arranged on a first end thereof so as to couple with a rear side of the second casing 40. The second connection piece 52 has a third rotating portion arranged on a second end thereof so as to join with the first connection piece 51. In this embodiment, the first rotating portion of the first connection piece 51 is a first coupling shaft 511 fixed on the first end of the first connection piece 51, and the first casing 30 also includes a first orifice 33 formed on the top surface thereof so as to join with the first coupling shaft 511 of the first connection piece 51, such that the first casing 30 is rotated and opened along the first coupling shaft 511. The second connection piece 52 is formed in an L shape, and the second rotating portion of the second connection piece 52 is a second coupling shaft 521 secured on the second end of the second connection piece 52. The second casing 40 also includes a second orifice 43 formed on the rear side thereof so as to connect with the second coupling shaft 521 of the second connection piece 52. In this embodiment, the second casing 40 includes a fixing seat 44 disposed on the rear side thereof, and the fixing seat 44 has the second orifice 43 defined thereon so that the second coupling shaft 521 of the second connection piece 52 is rotated along the second orifice 43 of the second casing 40 so as to rotatably open the first casing 30. The third rotating portion of the second connection piece 52 is a third coupling shaft 522 fixed on the first end of the second connection piece 52. The first connection piece 51 also includes a third orifice 512 defined on a second end thereof so as to connect with the third coupling shaft 522, such that the first connection piece 51 is in connection with the second connection piece 52. To flatly accommodate the first end of the first connection piece 51 and the first end of the second connection piece 52 on the top surface of the first casing 30, in this embodiment, the first casing 30 further includes a groove 34 defined on the top surface thereof so that when the first end of the first connection piece 51 and the first end of the second connection piece 52 are accommodated in the groove 34, the first connection piece 51 and the second connection piece 52 are accommodated on the top surface of the first casing 30 flatly. Furthermore, between the first casing 30 and the second casing 40 is defined a locking structure so that when the first casing 30 and the second casing 40 cover together, the locking structure locks the first casing 30 and the second casing 40. Since the locking structure is a well-known art, further remarks are omitted.

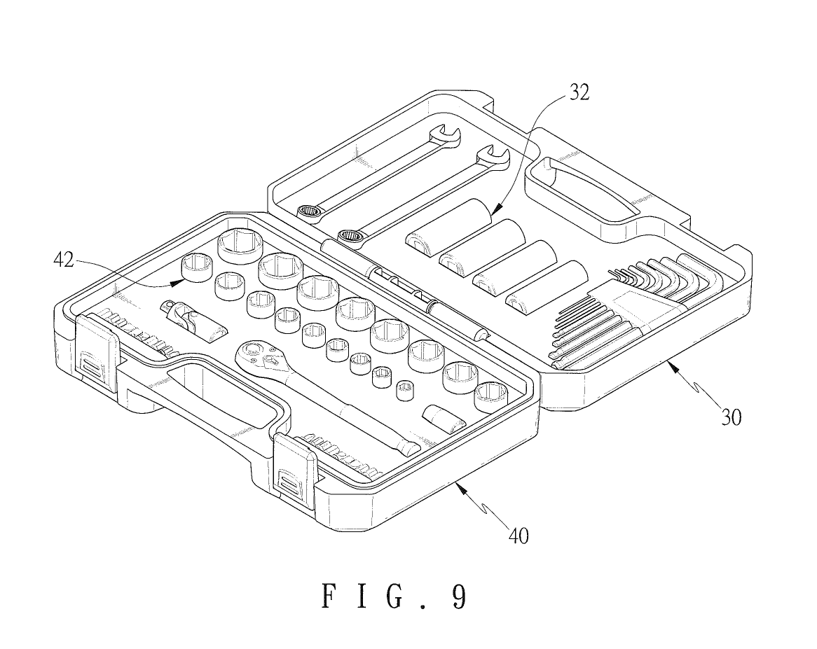

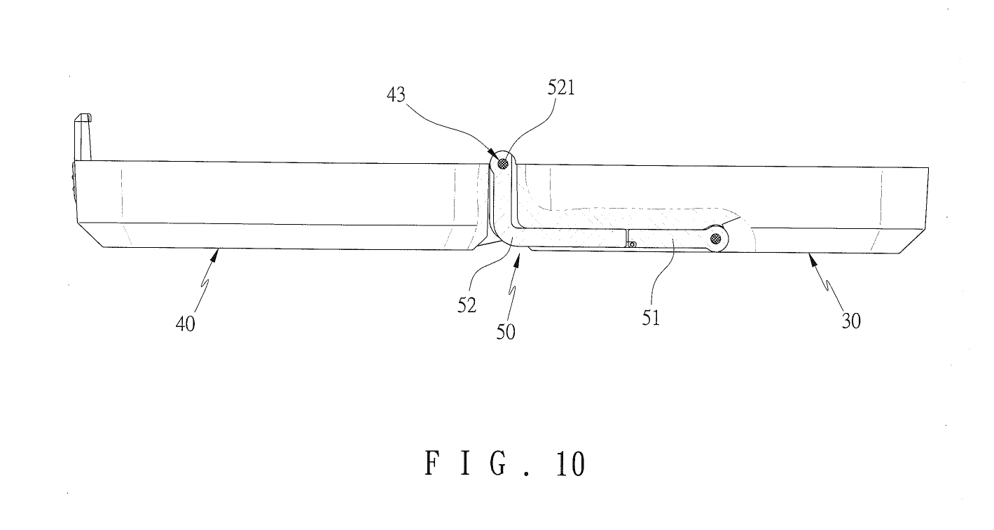

Referring further to FIGS. 9 and 10, when a display space is not limited by a horizontally placing space or position, the tool box is opened and placed horizontally, wherein the first casing 30 is rotated by rotating the second coupling shaft 521 of the second connection piece 52 along the second orifice 43 of the second casing 40 so as to open and display the tool box horizontally, such that the plurality of first accommodating portions 32 of the first casing 30 display the first tool set horizontally, and the second accommodating portion 42 of the second casing 40 displays the second tool set laterally.

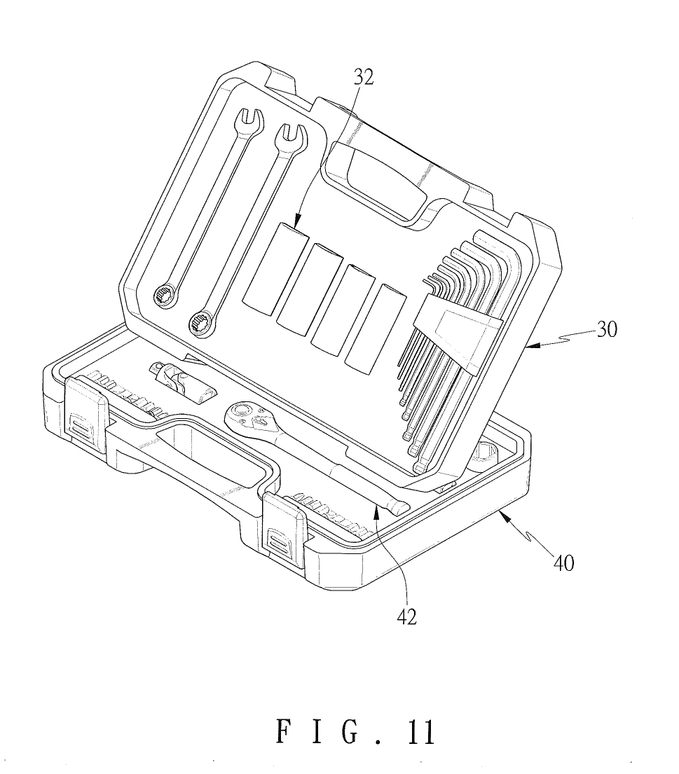

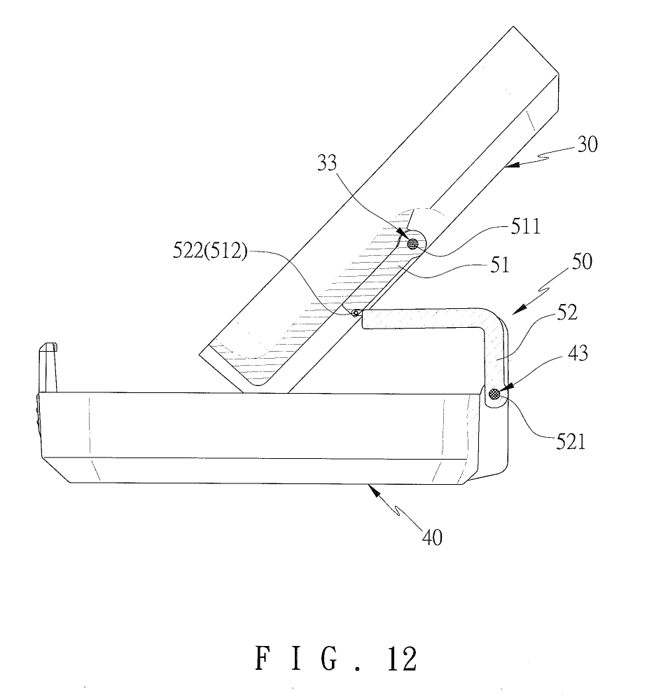

As shown in FIGS. 11 and 12, when the display space is not limited by a space height, the tool box is opened and placed upright. For example, the first casing 30 is rotated by rotating the second coupling shaft 521 of the second connection piece 52 along the second orifice 43 of the second casing 40, and the first casing 30 is rotated by rotating the first coupling shaft 511 of the first connection piece 51 along the first orifice 33 of the first casing 40, the first connection piece 51 rotates along the third orifice 512 of the first connection piece 51 by rotating the third coupling shaft 522 of the second connection piece 52, such that the first end of the second connection piece 52 pushes the first connection piece 51 to abut against the top surface of the first casing 30, and the first coupling shaft 511, the second coupling shaft 521 and the third coupling shaft 522 operate together so that the first casing 30 obliquely rotates and erects on the second casing 40, hence the first casing 30 is rotatably opened and placed upright, and the plurality of first accommodating portions 32 of the first casing 30 obliquely display the first tool set. Also, the second accommodating portion 42 of the second casing 40 faces upwardly so as to accommodate the second tool set stably.

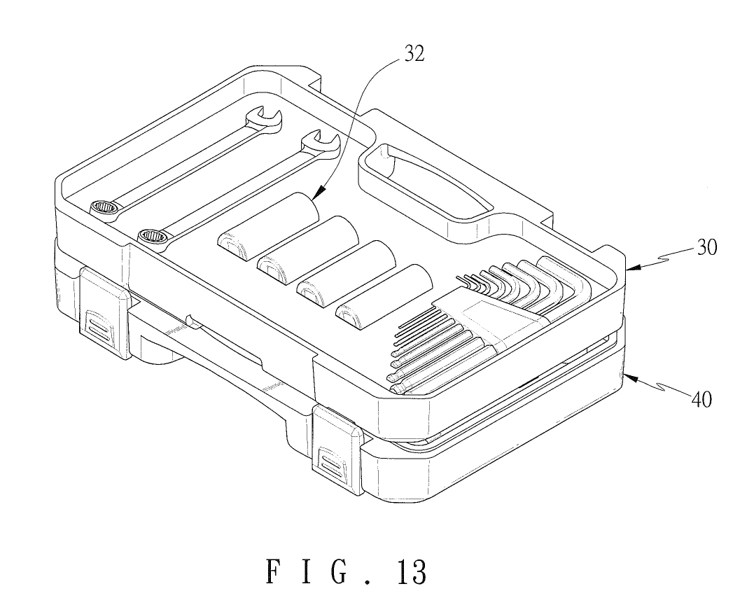

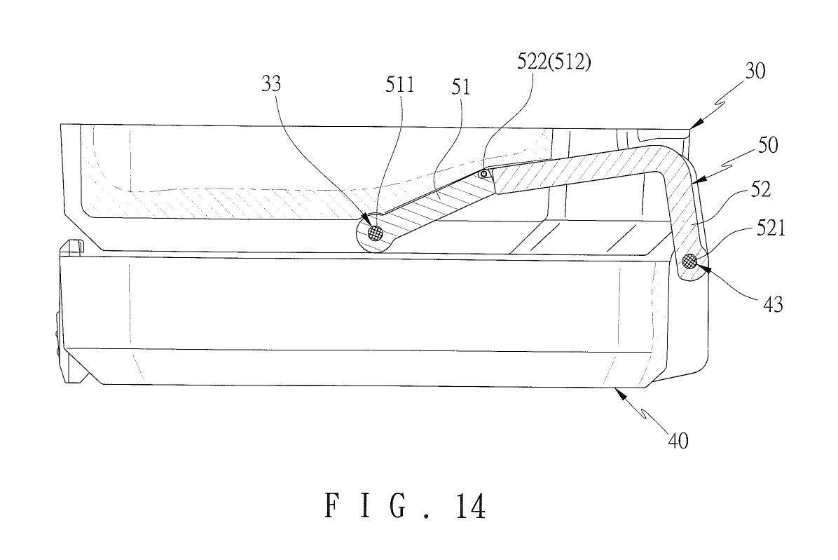

As illustrated in FIGS. 13 and 14, when the displays pace is limited by a horizontally placing space and a placing height, the tool box is opened stackedly. For example, the first casing 30 is rotated and opened by rotating the second coupling shaft 521 of the second connection piece 52 along the second orifice 43 of the second casing 40, and the first casing 30 rotates by rotating the first coupling shaft 511 of the first connection piece 51 along the first orifice 33 of the first casing 30, and the first connection piece 51 rotates by ways of the third coupling shaft 522 of the second connection piece 52, such that the first end of the first connection piece 51 and the first end of the second connection piece 52 contact with the top surface of the first casing 30 adversely, and the first casing 30 stacks on the second casing 40 and rotatably opens to display the first tool seat, hence the plurality of first accommodating portions 32 of the first casing 30 display the first tool set.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A display structure for a tool box comprising:
a first casing including a plurality of first accommodating portions defined therein so as to accommodate a first tool set;
a second casing covering with the first casing;
a connecting assembly including a first connection piece and a second connection piece which are connected together, the first connection piece having a first rotating portion formed on a first end thereof so as to couple with a top surface of the first casing, and the second connection piece having a second rotating portion arranged on a first end thereof so as to couple with a rear side of the second casing.

2. The display structure for the tool box as claimed in claim 1, wherein the second casing includes a second accommodating portion defined therein so as to accommodate a second tool set.

3. The display structure for the tool box as claimed in claim 1, wherein the first casing further includes a groove defined on the top surface thereof so that the connecting assembly is flatly accommodated on the top surface of the first casing.

4. The display structure for the tool box as claimed in claim 1, wherein the first rotating portion of the first connection piece is a first coupling shaft fixed on the first end of the first connection piece, and the first casing also includes a first orifice formed on the top surface thereof so as to join with the first coupling shaft of the first connection piece, such that the first casing is rotated along the first coupling shaft.

5. The display structure for the tool box as claimed in claim 1, wherein the second connection piece of the second connection piece is formed in an L shape, and the second rotating portion of the second connection piece is a second coupling shaft secured on the second end of the second connection piece, the second casing also includes a second orifice formed on the rear side thereof so as to connect with the second coupling shaft of the second connection piece, and the second coupling shaft of the second connection piece rotates along the second orifice.

6. The display structure for the tool box as claimed in claim 5, wherein the second casing includes a fixing seat disposed on the rear side thereof, and the fixing seat has the second orifice defined thereon.

7. The display structure for the tool box as claimed in claim 1, wherein the second connection piece of the connecting assembly has a third rotating portion for joining with the first connection piece.

8. The display structure for the tool box as claimed in claim 7, wherein the third rotating portion of the second connection piece is a third coupling shaft fixed on the first end of the second connection piece, and the first connection piece also includes a third orifice defined on a second end thereof so as to connect with the third coupling shaft.
